(19) United States
(12) Patent Application Publication
(10) Pub. No.: US 2014/0124391 A1
(43) Pub. Date: May 8, 2014

(54) Hospitality Bath & Hand Soap Bar

(71) Applicant: J. D. Spinnenweber, Cincinnati, OH (US)

(72) Inventor: J. D. Spinnenweber, Cincinnati, OH (US)

(21) Appl. No.: 14/011,092

(22) Filed: Aug. 27, 2013

Related U.S. Application Data
(62) Division of application No. 13/668,812, filed on Nov. 5, 2012, now abandoned.

(51) Int. Cl. C11D 17/04; B65D 85/00

(52) U.S. Cl. CPC C11D 17/048; B65D 85/70
USPC 206/216; 510/144

(57) ABSTRACT

The present invention is a home size bath or hand soap bar made of an inert core having the approximate same specific gravity as soap, said core being covered or coated with soap by spraying, molding, pressing, laminating or dipping. Also disclosed is a home size bath or hand soap bar having as its inert core a container of any size, shape or configuration for holding a variety of personal care products.

### CLAIM OF PRIORITY

This application claims priority to U.S. application Ser. No. 13/668812 which was filed on Nov. 5, 2012. application Ser. No. 13/668812 is incorporated by reference.

### BACKGROUND AND SUMMARY OF THE INVENTION

The present invention is a home size bath or hand soap bar made of an inert core having the approximate same specific gravity as soap, said core being covered or coated with soap by spraying, molding, pressing, laminating or dipping.

The present invention is a home size bath or hand soap having as its inert core a container of any size, shape or configuration for holding a variety of personal products.

This year there will be over one billion room nights sold by the Hospitality Industry. Many amenity items will be offered and consumed with each room night's sale, nothing more important than the bar of soap. The trend in the Hospitality Industry is to replicate the home environment away from home, with such items as bathrobes, slippers, a basket full of bathroom amenities, cordless phones, bath room scales, fogless mirrors and so on. But still the hospitality bar of soap does not fit an adult human hand. Soap bars in the Industry have increased from one ounce (28.3495 grams) to as many as two and one half ounces (70.87375 grams). When one considers that an average shower consumes only 6.0 grams of soap and the number of uses per guest stays in the range of 1 to 5 (depending upon which segment of the industry considered), it is easy to see the increase in cost and waste as the Industry chases the “home size” bar of soap. There have been great amounts of waste in the use of bars of soap with no good solution for reusing the wasted bars. The reuse of a bar of soap has a repulsive feel to it, for something used in such an intimate manner does not seem to qualify for recycling. Most bars are discarded but some make their way to various charitable institutions. The creation of a “home size” bar of soap, reduction of waste, and the reduction in cost is the goal of this invention. The invention is attempting to solve the issue of supplying and paying for only the amount of soap required to serve the particular bathing situation.

The present invention comprises a solution to the waste of hospitality industry soap by having at the core of the bar of soap an inert, less expensive material that is covered on all sides with soap. The inert material may be of any size, shape or configuration and would preferably lead to a product of comparable weight as a home size soap bar.

### Embodiment #1 A Container Soap Bar

The inert material may take the form of a container of any shape, size or configuration with one or more chambers for the purpose of holding a variety of products such as but not limited to, shampoo, conditioner, bubble bath or body gel and adhere to that container on any or all sides (except access end) a soap film, layer or coating by any means possible in the soap production industry such as but not limited to spraying, molding, pressing, laminating or dipping, thus creating an object of a size that can fit into an adult human hand and serve as a “home size” bar of bathing soap and a supply of other soap products in a single entity, producing a completely disposable object with a minimum of soap waste and cost with the added convenience of having all bathing materials in one compact package.

The above-mentioned embodiment may have the thickness of the film, layer or coating adjusted to fit the needs of the individual consumer needs in the various Hospitality Industry divisions, such as but not limited to economy, luxury, spas, resort, cruise or medical. This could allow for fine-tuning users needs and control waste and cost.

The above-mentioned embodiment may have various types soaps such as but not limited to, deodorant, moisturizer applied on the various sides or edges of the product. This could allow for bathing alternatives with the same product.

The above-mentioned embodiment may have various other materials added to the soap such as but not limited to, oatmeal, fragrances, oils to create soap and other material film, layer, coating. This could allow for further flexibility and options available to users.

The above-mentioned embodiment may have a colored or clear core or container to indicate soap wear or internal container products.

In addition to the novel features and advantages mentioned above, other features and advantages of the present invention will be readily apparent from the following descriptions of the drawings and exemplary embodiments.

### BRIEF DESCRIPTION OF THE DRAWINGS

FIG. 1 is a perspective view of the second embodiment according to the present invention.

FIG. 2 is a opposite end perspective view of the second embodiment according to the present invention.

FIG. 3 is a top view of the second embodiment according to the present invention.

FIG. 4 is an end view of the second embodiment according to the present invention.

FIG. 5 is a partial sectioned perspective view of the second embodiment according to the present invention.

### DETAILED DESCRIPTION OF EXEMPLARY EMBODIMENT(S)

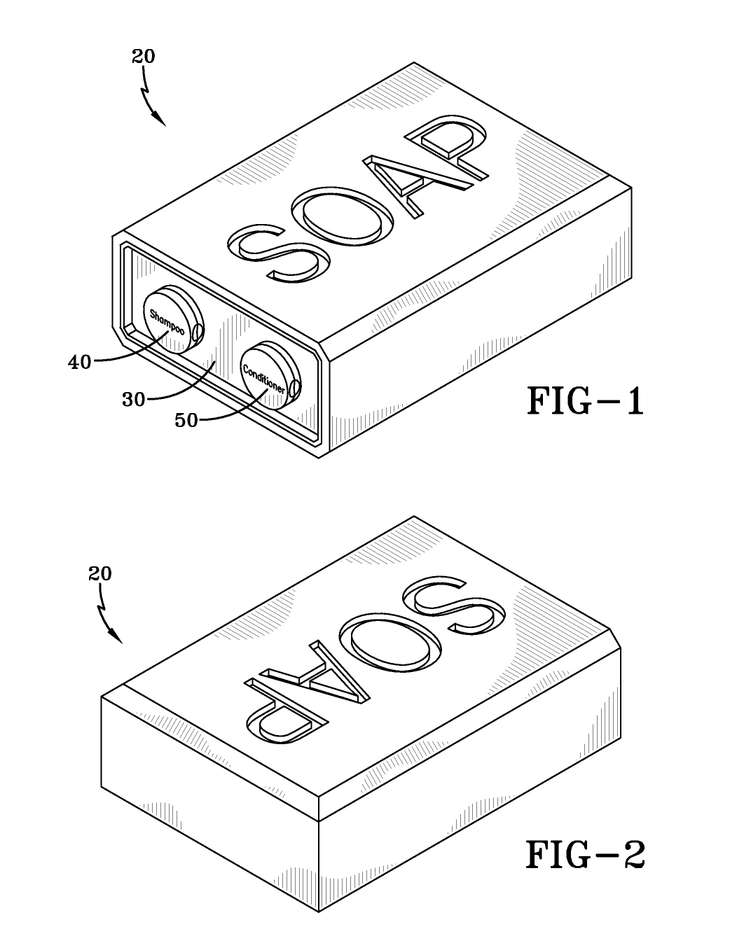

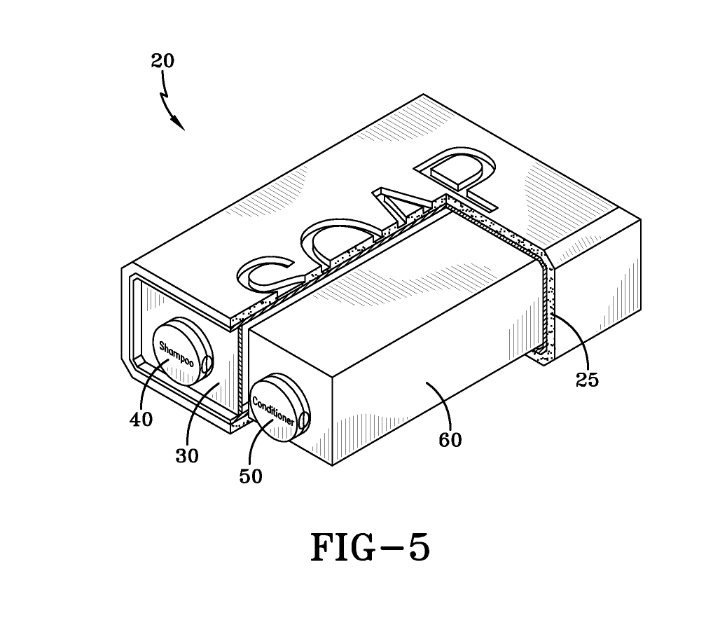

FIGS. 1 through 5 are views of an embodiment of the invention 20 in which an inert material is under a layer of soap 25. The inert material may be one or more containers or chambers of any size, shape or configuration 60. The access end 30 of the home size soap bar 20 may have one or more chamber lids 40 and/or 50 for accessing the material inside the one or more chambers 60. The one or more chambers 60 may then hold a variety of products such as but not limited to shampoo, conditioner, bubble bath and/or body gel. Thus, the home size soap bar 20 also supplies consumers with additional personal products desired during a bath or shower. The lids may be flipped open, screwed or punched open or any other method used by one skilled in the art of lids for personal bath products.

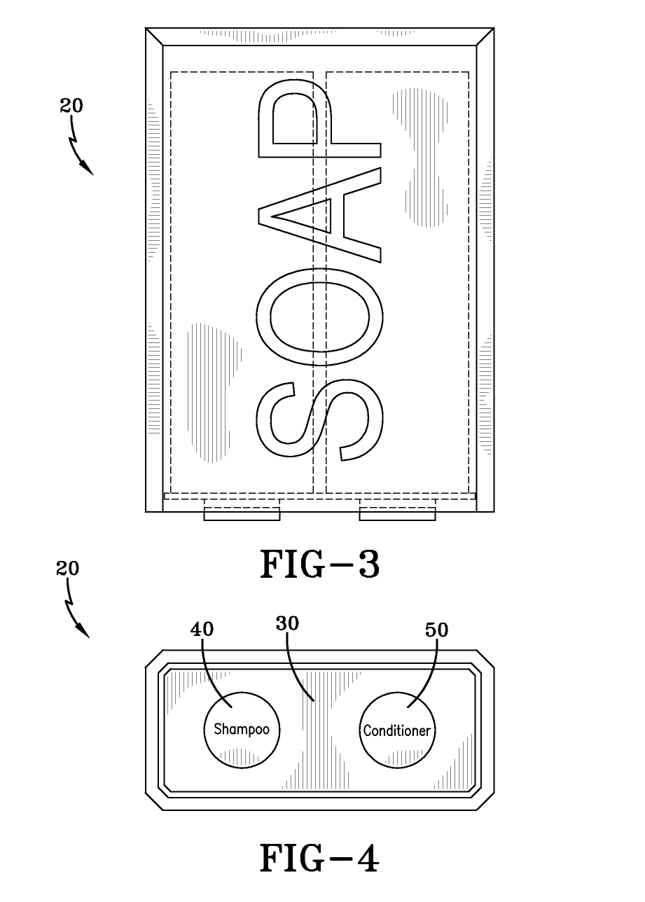

The home size soap bar 20 of FIGS. 3 through 7 is covered with a soap layer 25 on all sides of the bar except the access end 30. The soap layer 25 is applied by spraying, molding, pressing, laminating and/or dipping the one or more chambers 60 with soap. The method for adhering the soap layer 25 is not limited to those stated above but the one or more chambers 60 may be coated by any method known and used in the soap industry.

The exemplary embodiment herein disclosed is not intended to be exhaustive or to unnecessarily limit the scope of the invention. The exemplary embodiment was chosen and described in order to explain the principles of the present invention so that others skilled in the art may practice the invention. Having shown and described the exemplary embodiment of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. Soap bar comprising an inert core having the same or approximate specific gravity ingredient to that of soap, wherein a soap layer is adhered to said inert core by any means known in the soap industry for adhering soap to an inert object, including spraying, molding, pressing, laminating or dipping.

2. Soap bar comprising an inert core that made of one or more chambers or containers having lids for accessing the contents of said chambers or containers.

3. The soap bar of claim 2, wherein said one or more chambers or containers contains a liquid or semi-liquid personal bath product such as shampoo, conditioner, bubble bath or bath gel.

4. The soap bar of claim 2, wherein said soap bar is coated on all sides except the side for accessing the lid for said contents of said one or more chambers or containers with a soap layer of varying thickness.

5. The soap bar of claim 2, wherein said method for adhering said soap layer to said one or more chambers or containers is selected from a method consisting of spraying, molding, pressing, laminating, extruding, casting and dipping or any combination thereof.

6. The soap bar of claim 2, wherein at least one additional ingredient has been added to the soap, wherein said at least one ingredient is selected from the group consisting of oatmeal, fragrance, oil and coating.
